(19) United States
(12) Patent Application Publication
(10) Pub. No.: US 2013/0291311 A1
(43) Pub. Date: Nov. 7, 2013

(54) Ventilating Pad With Buffer And Elastic Support

(71) Applicant: Yu-Chieh Wang, Tainan City (TW)

(72) Inventor: Yu-Chieh Wang, Tainan City (TW)

(21) Appl. No.: 13/462,175

(22) Filed: May 2, 2012

(51) Int. Cl. A47C 17/00; A47G 9/02; A47C 20/00; D05B 93/00; B32B 3/28

(52) U.S. Cl. 5/724; 112/402; 428/166; 5/652.1; 5/490

(57) ABSTRACT

A ventilating pad with buffer and elastic support is formed by connecting an underlying layer, a middle layer and a surface layer with one another, characterized in that the underlying layer is disposed under the middle layer, and the middle layer is disposed under the surface layer, and the middle layer comprises a plurality of elastic protrusions protruded from the top of the middle layer, and the surface layer is attached flatly with the middle layer and along the direction of the elastic protrusion of the middle layer, and a gap is formed between two adjacent elastic protrusions, such that a downwardly concave air passage is formed between the adjacent elastic protrusions, such that the application of the ventilating pad will not cause sweltering or discomfort.

### BACKGROUND OF THE INVENTION

1. Field of the Invention

The present invention relates to a ventilating pad with buffer and elastic support, in particular to the pad capable of absorbing some of the body pressure, providing a ventilation effect and preventing sweltering even after a long time of contact with the pad.

2. Description of the Related Art

In general, a conventional pad such as a mat is made of fabric and formed by a sewing technique. However, sweltering will occur easily after a long time of contact with the pad, and the pad is unable to absorb a user's body weight, and thus discomfort occurs at some part of the user's body.

### SUMMARY OF THE INVENTION

In view of the aforementioned drawbacks of the conventional pad, the inventor of the present invention based on years of experience in the related industry to conduct extensive researches and experiments, and finally develop the ventilating pad with buffer and elastic support in accordance with the present invention.

Therefore, it is a primary objective of the present invention to provide a ventilating pad with buffer and elastic support capable of absorbing some of the body pressure, providing a ventilation effect, and preventing sweltering even after a long time of contact with the pad.

The ventilation pad of the present invention is formed by connecting an underlying layer, a middle layer and a surface layer with one another, wherein the underlying layer is disposed under the middle layer, and the middle layer is disposed under the surface layer, and the middle layer comprises a plurality of elastic protrusions protruded from the top of the middle layer, and the surface layer is attached flatly with the middle layer and along the direction of the elastic protrusion of the middle layer, and a gap is formed between two adjacent elastic protrusions, such that a downwardly concave air passage is formed between the adjacent elastic protrusions, such that the application of the ventilating pad will not cause sweltering or discomfort.

In the ventilating pad with buffer and elastic support, the underlying layer, the middle layer and the surface layer are coupled by an adhesive.

In the ventilating pad with buffer and elastic support, the underlying layer, the middle layer and the surface layer are coupled by a sewing technique.

In the ventilating pad with buffer and elastic support, the pad is a mat.

In the ventilating pad with buffer and elastic support, the pad is a seat cushion having at least one band disposed on a side of the pad.

In the ventilating pad with buffer and elastic support, the pad is a back cushion having a backrest protruded from a position corresponding to a user's waist.

In the ventilating pad with buffer and elastic support, the pad is a pillow cover having at least one elastic circular band.

In the ventilating pad with buffer and elastic support, the pad is a mattress.

In the ventilating pad with buffer and elastic support, the surface layer is made of cotton.

In the ventilating pad with buffer and elastic support, the surface layer is made of polyester.

In the ventilating pad with buffer and elastic support, the surface layer is made of acrylic.

In the ventilating pad with buffer and elastic support, the surface layer is made of nylon.

In the ventilating pad with buffer and elastic support, the surface layer is made of polypropylene.

In the ventilating pad with buffer and elastic support, the surface layer is made of polyvinyl chloride (PVC).

In the ventilating pad with buffer and elastic support, the middle layer is made of latex foam.

In the ventilating pad with buffer and elastic support, the middle layer is made of silica foam.

In the ventilating pad with buffer and elastic support, the middle layer is made of polyurethane (PU) foam.

In the ventilating pad with buffer and elastic support, the middle layer is made of polymer foam.

In the ventilating pad with buffer and elastic support, the underlying layer is made of fabric.

In the ventilating pad with buffer and elastic support, the underlying layer is made of anti-slip fabric.

In the ventilating pad with buffer and elastic support, the underlying layer is made of polyvinyl chloride (PVC).

In the ventilating pad with buffer and elastic support, the underlying layer is made of thermoplastic elastomer (TAE).

In the ventilating pad with buffer and elastic support, the underlying layer is made of polyethylene (PE).

In the ventilating pad with buffer and elastic support, the underlying layer is made of polypropylene (PP).

In the ventilating pad with buffer and elastic support, the underlying layer is made of polyurethane (PU).

In the ventilating pad with buffer and elastic support, the underlying layer is made of thermoplastic polyurethane resin (TPU).

### BRIEF DESCRIPTION OF THE DRAWINGS

FIG. 1 is a perspective view of a first preferred embodiment of the present invention;

FIG. 2 is an exploded front view of the first preferred embodiment of the present invention;

FIG. 3 is a first perspective exploded view of a second preferred embodiment of the present invention;

FIG. 4 is a second perspective exploded view of the second preferred embodiment of the present invention;

FIG. 5 is a perspective view of a third preferred embodiment of the present invention;

FIG. 6 is a schematic view of an application of a fourth preferred embodiment of the present invention;

FIG. 7 is a perspective view of a fifth preferred embodiment of the present invention; and

FIG. 8 is a partial cross-sectional view of a fifth preferred embodiment of the present invention.

### DETAILED DESCRIPTION OF THE PREFERRED EMBODIMENTS

To make it easier for our examiner to understand the technical characteristics and measures of the present invention to achieve the aforementioned objects and effects, we use preferred embodiments with related drawings for the detailed description of the present invention as follows.

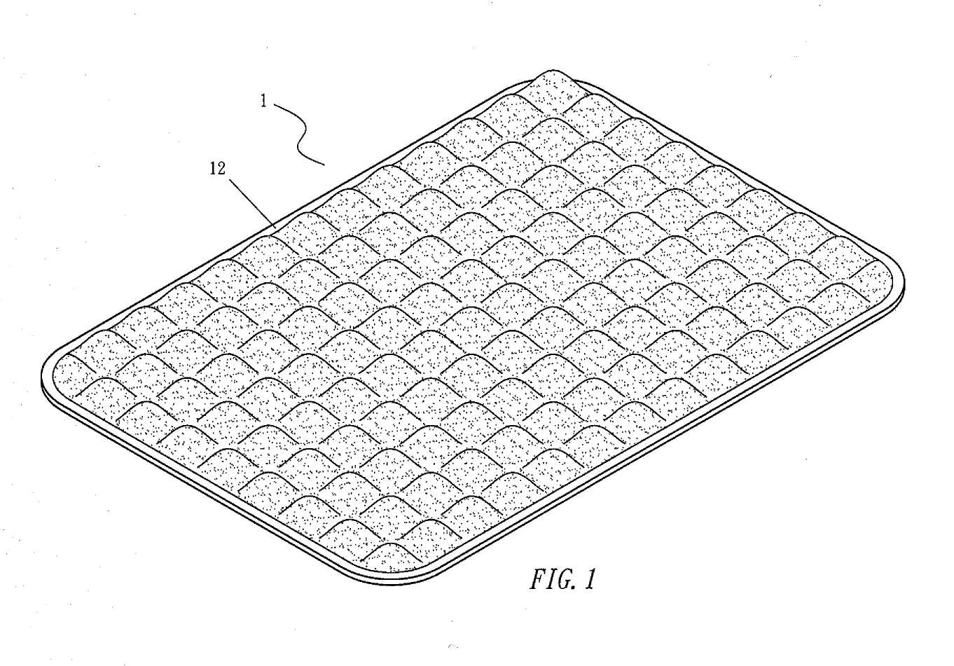

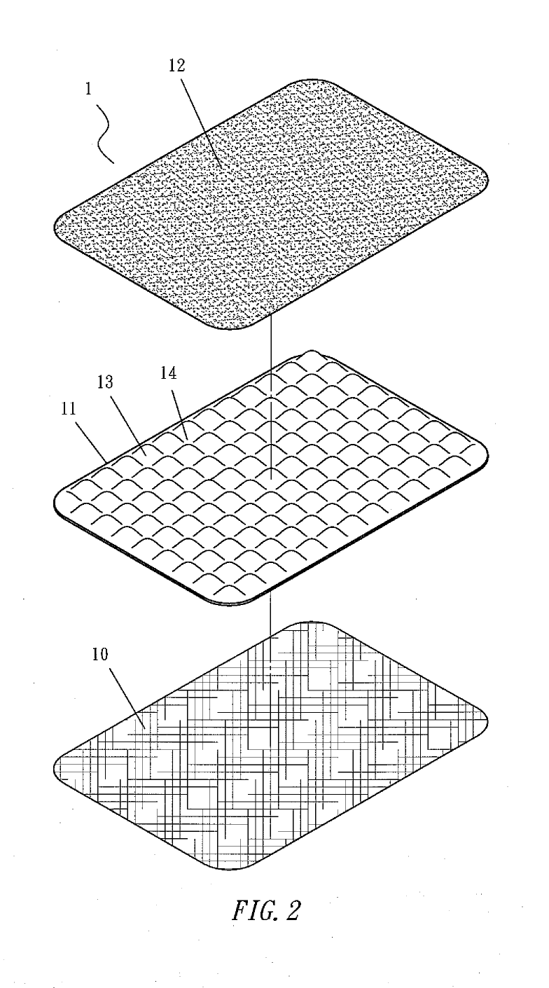

With reference to FIGS. 1 and 2 for a ventilating pad with buffer and elastic support in accordance with the first preferred embodiment of the present invention, the ventilating pad is a mat 1 formed by connecting an underlying layer 10, a middle layer 11 and a surface layer 12 with one another, wherein the underlying layer 10 is disposed under the middle layer 11, and the middle layer 11 is disposed under the surface layer 12, and the middle layer 11 has a plurality of elastic protrusions 13 protruded from the top of the middle layer 11, and the surface layer 12 is attached flatly on the middle layer 11 and along the direction of the elastic protrusion 13 of the middle layer 11, and a gap 14 is formed between adjacent elastic protrusions 13, such that a downwardly concave air passage is formed between the elastic protrusion 13 and the gap 14. When a user's feet step on the mat 1, the elasticity of the elastic protrusion 13 of the middle layer 11 can absorb the pressure of the user's feet effectively, so that the user will not feel uncomfortable even after the user has been standing there for a long time. When the user's feet no longer step on the mat 1, the elastic protrusion 13 of the middle layer 11 will resume its original shape.

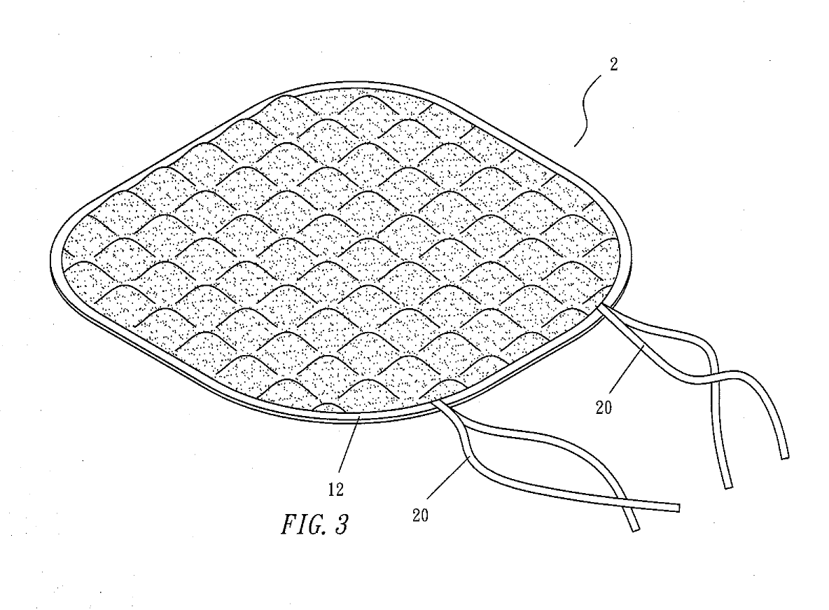

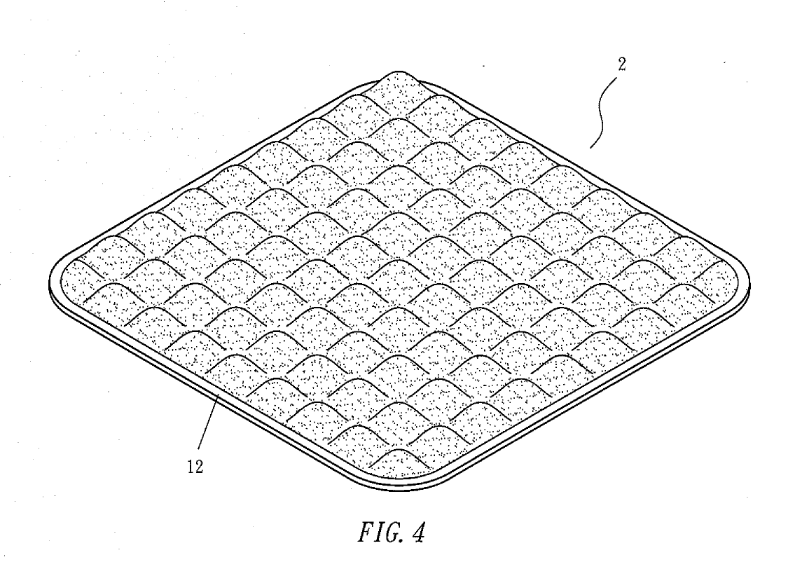

With reference to FIGS. 3 and 4 for a ventilating pad with buffer and elastic support in accordance with the second preferred embodiment of the present invention, the difference between the second preferred embodiment and the first preferred embodiment resides on that the pad of the second preferred embodiment is a seat cushion 2 having at least one band 20 disposed on a side of the seat cushion 2 (as shown in FIG. 3), such that the band 20 can be tied onto a frame of a chair (not shown in the figure) to fix the seat cushion 2. Even after the user has sat on the seat cushion 2 for a long time, the user will not feel uncomfortable.

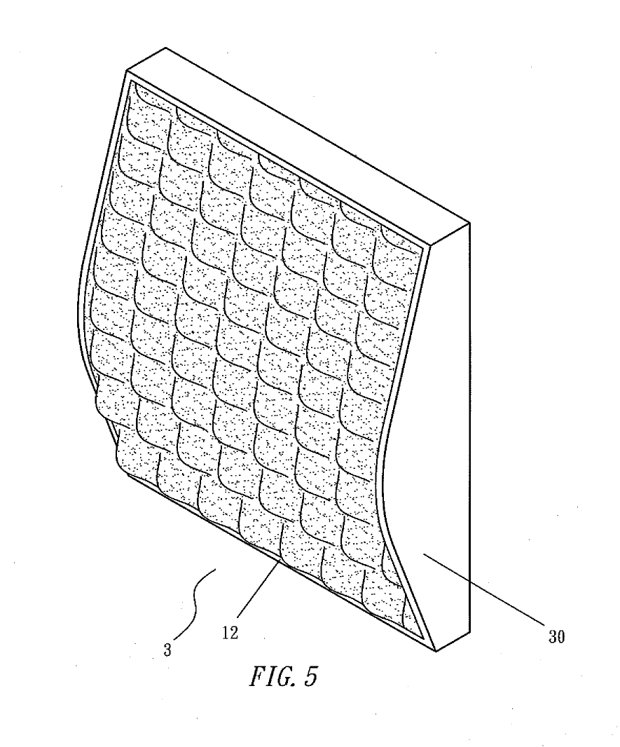

With reference to FIG. 5 for a ventilating pad with buffer and elastic support in accordance with the third preferred embodiment of the present invention, the difference between the third preferred embodiment and the first preferred embodiment resides on that the pad of the third preferred embodiment is a back cushion 3 having a bulge 30 protruded from a position corresponding to a user's waist, such that when the user's waist leans against the bulge 30 of the back cushion 3, the lumber pressure of the user can be reduced significantly.

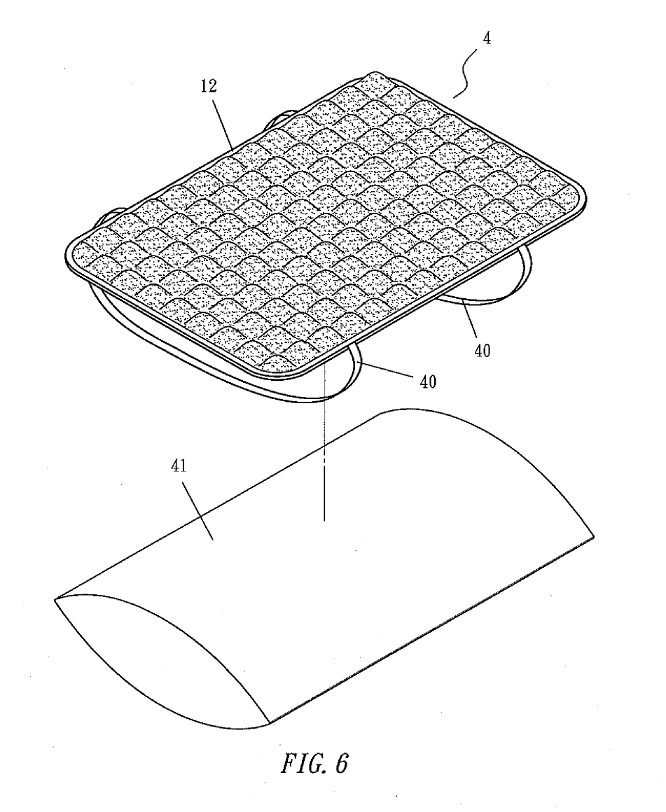

With reference to FIG. 6 for a ventilating pad with buffer and elastic support in accordance with the fourth preferred embodiment of the present invention, the difference between the fourth preferred embodiment and the first preferred embodiment resides on that the pad of the third preferred embodiment is a pillow cover 4 having at least one elastic circular band 40, and the band 40 is sheathed on a surface of a pillow 41 to combine the pillow cover 4 with the pillow 41, such that the user's head can rest on the pillow cover 4 to achieve a more comfortable rest.

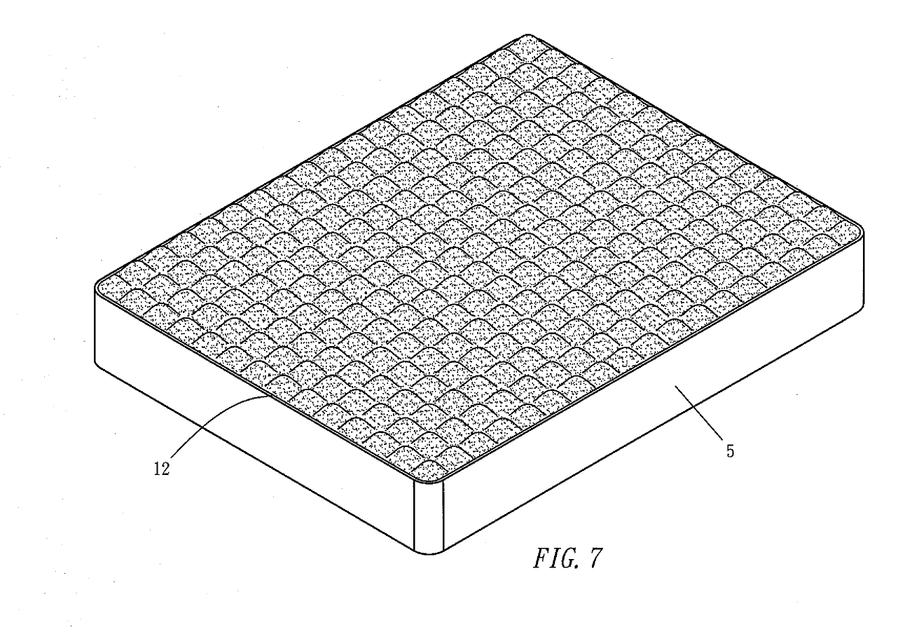

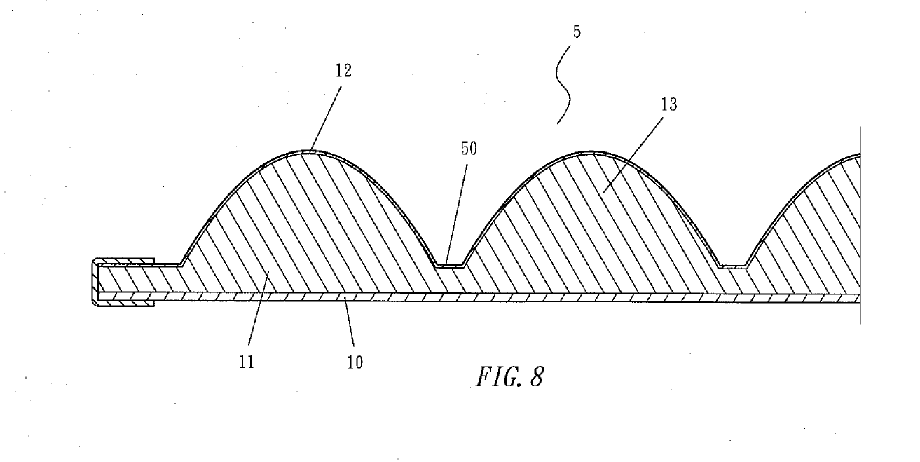

With reference to FIGS. 7 and 8 for a ventilating pad with buffer and elastic support in accordance with the fifth preferred embodiment of the present invention, the difference between the fifth preferred embodiment and the first preferred embodiment resides on that the pad of the fifth preferred embodiment is a mattress 5, and the elastic protrusion 13 of the middle layer 11 is in a upwardly convex arc shape, and a concave surface 50 is formed between adjacent elastic protrusions 13, such that after the surface layer 12 and the middle layer 11 are attached flatly with each other, a continuous wavy shape is formed. When the user lies flatly on the mattress 5, the user can rest comfortably.

In a preferred embodiment, the underlying layer 10 is made of cotton, polyester, acrylic, nylon, polypropylene, polyvinyl chloride, fabric or anti-slip fabric.

In a preferred embodiment, the surface layer 12 is made of polyvinyl chloride, thermoplastic elastomer, polyethylene, polypropylene, polyurethane or thermoplastic polyurethane resin.

In a preferred embodiment, the middle layer 11 is made of latex foam, silica foam, polyurethane (PU) foam or polymer foam.

In a preferred embodiment, the underlying layer 10, the middle layer 11 and the surface layer 12 are coupled with one another by an adhesive

In a preferred embodiment, the underlying layer 10, the middle layer 11 and the surface layer 12 are coupled with one another by a sewing technique

In summation of the description above, the present invention has the following advantages or effects:

1. The pad of invention provides a ventilation effect, such that sweltering will not occur even after a long time of use of the pad.

2. The pad of the invention provides a buffer and elastic support effect, such that discomfort will not occur even after a long time of use of the pad.

Thus, the present invention improves over the prior art and complies with patent application requirements, and thus is duly file for patent application. While the invention has been described by means of specific embodiments, numerous modifications and variations could be made thereto by those skilled in the art without departing from the scope and spirit of the invention set forth in the claims.

What is claimed is:

1. A ventilating pad with buffer and elastic support, formed by connecting an underlying layer, a middle layer and a surface layer with one another, characterized in that the underlying layer is disposed under the middle layer, and the middle layer is disposed under the surface layer, and the middle layer comprises a plurality of elastic protrusions protruded from the top of the middle layer, and the surface layer is attached flatly with the middle layer and along the direction of the elastic protrusion of the middle layer, and a gap is formed between two adjacent elastic protrusions, such that a downwardly concave air passage is formed between the adjacent elastic protrusions.

2. The ventilating pad with buffer and elastic support of claim 1, wherein the underlying layer, middle layer and surface layer are coupled with one another by an adhesive.

3. The ventilating pad with buffer and elastic support of claim 1, wherein the underlying layer, the middle layer and the surface layer are coupled with one another by a sewing technique.

4. The ventilating pad with buffer and elastic support of claim 1, wherein the pad is a mat.

5. The ventilating pad with buffer and elastic support of claim 3, wherein the pad is a seat cushion having at least one band disposed on a side of the pad.

6. The ventilating pad with buffer and elastic support of claim 3, wherein the pad is a back cushion having a bulge protruded form a position corresponding to a user's waist.

7. The ventilating pad with buffer and elastic support of claim 3, wherein the pad is a pillow cover having at least one elastic circular band.

8. The ventilating pad with buffer and elastic support of claim 3, wherein the pad is a mattress, and each elastic protrusion is in an upwardly lifted arc shape, a concave surface is formed between two adjacent elastic protrusions, such that after the surface layer and the middle layer are coupled, a continuous wavy shape is formed.

9. The ventilating pad with buffer and elastic support of claim 2, wherein the pad is a seat cushion having at least one band disposed on a side of the pad.

10. The ventilating pad with buffer and elastic support of claim 2, wherein the pad is a back cushion having a bulge protruded form a position corresponding to a user's waist.

11. The ventilating pad with buffer and elastic support of claim 2, wherein the pad is a pillow cover having at least one elastic circular band.

12. The ventilating pad with buffer and elastic support of claim 2, wherein the pad is a mattress, and each elastic protrusion is in an upwardly lifted arc shape, a concave surface is formed between two adjacent elastic protrusions, such that after the surface layer and the middle layer are coupled, a continuous wavy shape is formed.

13. The ventilating pad with buffer and elastic support of claim 1, wherein the pad is a seat cushion having at least one band disposed on a side of the pad.

14. The ventilating pad with buffer and elastic support of claim 1, wherein the pad is a back cushion having a bulge protruded form a position corresponding to a user's waist.

15. The ventilating pad with buffer and elastic support of claim 1, wherein the pad is a pillow cover having at least one elastic circular band.

16. The ventilating pad with buffer and elastic support of claim 1, wherein the pad is a mattress, and each elastic protrusion is in an upwardly lifted arc shape, a concave surface is formed between two adjacent elastic protrusions, such that after the surface layer and the middle layer are coupled, a continuous wavy shape is formed.
